(19) United States
(12) Patent Application Publication
(10) Pub. No.: US 2025/0260427 A1
(43) Pub. Date: Aug. 14, 2025

(54) METHOD AND APPARATUS FOR REDUCING THE EFFECT OF CARRIER FREQUENCY OFFSET ERRORS IN WIRELESS COMMUNICATIONS SYSTEMS

(71) Applicant: Analog Devices International Unlimited Company, Limerick (IE)

(72) Inventors: Patrick Pratt, Mallow (IE); Philip Eugene Quinlan, Glounthaune (IE)

(21) Appl. No.: 18/919,248

(22) Filed: Oct. 17, 2024

Related U.S. Application Data
(60) Provisional application No. 63/556,678, filed on Feb. 22, 2024.
(60) Provisional application No. 63/551,216, filed on Feb. 8, 2024.

(51) Int. Cl. H04B 1/10

(52) U.S. Cl. CPC H04B 1/1027

(57) ABSTRACT

There is provided methods and apparatuses for tuning a Viterbi detector at a receiver of a wireless communications system. They include: receiving a transmitted bit stream at the receiver; detecting a frequency mismatch between a frequency of a carrier frequency and a frequency of a local oscillator at the receiver to derive a carrier frequency offset error; determining a tuning parameter based on the carrier frequency offset error, the tuning parameter being a value between 0 and 1; and applying the tuning parameter to a Viterbi detuning algorithm in order to reduce the effect of the carrier frequency offset error on performance of the Viterbi detector.

### CLAIM OF PRIORITY

This application claims priority to U.S. Provisional Application Nos. 63/556,678, filed Feb. 22, 2024, and 63/551,216, filed Feb. 8, 2024, which are hereby incorporated by reference herein in their entireties.

### FIELD

This application relates generally to methods and apparatuses for reducing the effect of carrier frequency offset errors and, in particular but not exclusively, to methods and apparatus for reducing the effect of carrier frequency offset errors at a receiver of a wireless communications system.

### BACKGROUND

Carrier frequency errors in wireless communications systems may arise due to inaccuracies in the transmitter carrier frequency and the local oscillator frequency of the receiver.

In order to mitigate these errors, several solutions may be employed. For example, high-precision oscillators with low deviation may be used to reduce frequency errors at both the transmitter and the receiver. Further, pilot signals may be embedded within the transmitted data allows the receiver to estimate and correct carrier frequency offsets, addressing errors introduced during modulation and demodulation. Additionally, advanced digital signal processing techniques may be used to estimate and correct frequency errors in real-time, ensuring proper alignment with the anticipated carrier frequency. Continuous synchronization algorithms may be used to adjust frequency synchronization over time to account for changes due to temperature drift or movement, thus maintaining long-term frequency stability.

### SUMMARY OF THE DISCLOSURE

The systems and methods of the present disclosure provide ways in which to reduce carrier frequency errors in wireless communications systems, in particular, for improving the accuracy of Viterbi detection at the receiver.

In one aspect of the present disclosure, there is provided a method of tuning a Viterbi detector at a receiver of a wireless communications system, the method comprising: receiving a transmitted bit stream at the receiver; detecting a frequency mismatch between a carrier frequency and a local oscillator frequency at the receiver to derive a carrier frequency offset error; determining a tuning parameter based on the carrier frequency offset error, the tuning parameter being a value between 0 and 1; and applying the tuning parameter to a Viterbi detuning algorithm in order to reduce the effect of the carrier frequency offset error on the Viterbi detector.

During transmission in a wireless communications system, a transmitted signal may have two frequency components: (a) the carrier frequency; and (b) a frequency of the carrier signal may be modulated further (for example, using GFSK modulation) to represent the transmitted bit stream in preparation for wireless communication and then demodulated (for example, using GFSK demodulation) after being received at the receiver. The carrier frequency offset error of the transmitter that is derived at the receiver of the wireless communications system is primarily caused by errors in (a). Therefore, after the transmitted bit stream is received at the receiver, detecting a frequency mismatch between a carrier frequency and a local oscillator frequency at the receiver does not typically include modulation/demodulation errors.

A tuning parameter is determined based on the carrier frequency offset error, and the tuning parameter is a value between 0 and 1. The tuning parameter is applied to a Viterbi detuning algorithm in order to reduce the negative impact of the carrier frequency offset error on the performance of the Viterbi detector. A Viterbi detuning algorithm may be dynamically used in a Viterbi detector to detect the transmitted bit stream at the received, for example, maintaining a history of past record of candidate bit sequences and finds a most likely sequence of bits. The tuning parameter may be representative of a confidence metric for how accurate the Viterbi detuning algorithm is based on how much carrier frequency offset error is present in the transmitted bit stream.

In some examples, both the transmit carrier frequency and the local oscillator frequency at the receiver may comprise errors. That is to say, a frequency mismatch error may be caused by a combination of frequency errors in both the carrier frequency and the local oscillator frequency at the receiver.

The transmitter and receiver frequencies may be derived from separate reference quartz crystals. One crystal may reside on the transmitter PCB and one crystal may reside on the receiver PCB, and both crystals may be physically separated by some distance. The crystals may be quite accurate but typically each may have a +/−10 to +/−20 ppm frequency error. Therefore, frequency errors may exist on both the carrier frequency and the local oscillator at the receiver. In the present disclosure, the two frequency errors may both be corrected at the receiver in order to accurately retrieve the transmitted stream of bits/packet of data.

As an example, the carrier frequency could be +50 kHz in error. The receiver's local oscillator frequency error could be −40 kHz. In this case, a total frequency mismatch of (50 KHz−(−40 kHz)=90 KHz exists.

The carrier frequency may be a center frequency of a transmitted carrier signal and the local oscillator frequency may be a center frequency of the local oscillator.

An input and an output to the Viterbi detuning algorithm may be a complex number.

Applying the tuning parameter to the Viterbi detuning algorithm may comprise low pass filtering, preferably low pass filtering of a cross correlation of the receiver input with candidate transient waveforms multiplied by the historic phase waveform. In some examples, the method further comprises multiplying a complex conjugate output of the low pass filtering with the input to the low pass filter. In some examples, the method further comprises taking a Real value of the output of the low pass filtering as a branch metric to be used in a reminder of the Viterbi detection process.

The method may further comprise determining a tuning parameter of 1 when a carrier frequency offset error below a lower threshold is detected. In an example, the tuning parameter may be determined as 0 when no carrier frequency offset error is detected. This may be the case when the receiver is perfectly coherent.

The method may further comprise determining a tuning parameter of 0 when a carrier frequency offset error above an upper threshold is detected. In an example, the method may further comprise bypassing the Viterbi detuning algorithm for a current transmitted bit stream and taking the output of the Viterbi detuning algorithm as a previous output of the Viterbi detector.

The tuning parameter that has a value between 0 and 1 is not limited to being 0 or 1 depending on the carrier frequency offset error being detected above or below a threshold. Instead, the tuning parameter may be a function of the magnitude of the carrier frequency offset error and ranges between 0 and 1, the tuning parameter being 1 when the carrier frequency offset error is zero, and tending towards 0, as the carrier frequency offset error increases.

The method may further comprise automatically adjusting the tuning parameter based on the carrier frequency offset error, preferably in a feedforward manner.

The method may further comprise dynamically adjusting the tuning parameter based on the carrier frequency offset error.

Detecting a frequency mismatch may comprise performing a Fast Fourier Transform on the transmitted bit stream at the receiver or measuring a frequency error using a feedforward or feedback automatic frequency control loop. These techniques may make observations of a demodulated data stream (for example, during the packet header/preamble period) at the receiver to measure the carrier frequency offset error.

The transmitted bit stream may be encoded and/or modulated, and the method may further comprise decoding and/or demodulating the transmitted bit stream.

The transmitted bitstream may be (a) uncoded (no coding is applied) or (b) it may be encoded with some form of Forward Error Correction (FEC) coding such as Turbo Coding, Convolutional Coding etc.

The method may further comprises also applying Turbo Coding to the transmitter bit stream at the transmitter side.

The transmitted bitstream may typically then be modulated on to a transmit carrier using a phase/frequency/amplitude modulation technique at the transmitter side.

The method may further comprise demodulating the transmitted bit stream by calculating a phase and a magnitude of the transmitted bit stream.

The method may further comprise decoding the transmitted bit stream, for example, by identifying and correcting errors, and converting the encoded data back into its original format.

The method may further comprise outputting a detected bit stream from the receiver.

In another aspect of the present disclosure, there is provided an apparatus for tuning a Viterbi detector at a receiver of a wireless communications system, the device comprising: an automatic frequency control block, configured to detect a frequency mismatch between a carrier frequency and a local oscillator frequency at the receiver to derive a carrier frequency offset error; an automatic frequency control residual block, configured to determine a tuning parameter based on a carrier frequency offset error, the tuning parameter being a value between 0 and 1; and a Viterbi detector, configured to apply the tuning parameter to a Viterbi detuning algorithm in order to reduce the effect of carrier frequency offset error on performance of the Viterbi detector.

The Viterbi detector may comprise a low pass filter, and preferably a first order low pass filter.

If there is little or no carrier frequency offset error present in the transmitted bit stream, or the carrier frequency offset error is below a lower threshold, then the tuning parameter may be determined as 1. In this case, an output of the Viterbi detuning algorithm may be taken as an output of the low pass filter.

If there is finite or significant carrier frequency offset error present in the transmitted bit stream, or carrier frequency offset error is above an upper threshold, then the tuning parameter may be determined as 0 (i.e., detuned). In this case, the output of the low pass filter is the complex conjugate of low pass filtered version of the input, where the pole of the filter is determined by the tuning parameter alpha, 1≤α>0. As the carrier frequency offset error decreases, the tuning parameter may increase towards 1, and the complex conjugate product becomes the original input, i.e., there is no filtering and no detuning apply and the maximum performance of the Viterbi can be achieved.

The product of the complex conjugate low pass filtered output with the filter input may then be formed. The real component of this product may then become the detuned branch metric. This detuning process has the effect of reducing the impact of frequency offset errors on the branch metric and hence on the Viterbi detector performance.

The automatic frequency control residual block of the apparatus is configured to determine a tuning parameter that has a value between 0 and 1 but it is not limited to being 0 or 1 depending on the carrier frequency offset error being detected above or below a threshold. Instead, the tuning parameter may be a function of the magnitude of the carrier frequency offset error and ranges between 0 and 1, the tuning parameter being 1 when the carrier frequency offset error is zero, and tending towards 0, as the carrier frequency offset error increases.

The Viterbi detector may be configured to dynamically adjust the tuning parameter based on the carrier frequency offset error.

The apparatus may further comprise an encoder and decoder and/or a modulator and a demodulator.

### Definitions

‘Carrier frequency offset’ is defined as a difference between an actual carrier frequency of a transmitted signal and an expected carrier frequency at the receiver (typically referred to as the receiver's Local Oscillator” frequency). This offset can occur due to inaccuracies in the transmitter carrier frequency and the local oscillator frequency of the receiver as well as during modulation and demodulation of the signal.

In a wireless communications system, a signal may be encoded and/or modulated at the transmitter, and demodulated and/or decoded at the receiver.

‘Encoding’ is a process that involves converting data into a specific format or code in order to prepare it for transmission. In wireless communications, encoding often includes adding error detection and correction codes to ensure data integrity during transmission.

‘Decoding’ is the reverse process of encoding. It involves converting the received coded data back into its original format. Decoding may also include checking for and correcting any errors that may have occurred during transmission.

In ‘encoding’ and ‘decoding’, the input is a stream of bits and the output is a stream of bits.

‘Modulation’ is a process of varying a carrier signal in order to transmit data. In wireless communications, this typically involves altering the amplitude, frequency, or phase of the carrier signal to modulate the data onto the carrier signal.

‘Demodulation’ is the reverse process of modulation. It involves extracting the original data from the carrier signal, reversing the amplitude, frequency, or phase of the received signal.

In ‘modulation’, the input is a stream of bits and the output is a phase and/or amplitude. In ‘demodulation’, the input is a phase and/or amplitude and the output is a stream of bits.

‘Detecting’ is the process of identifying the presence of a signal or specific data within the transmitted signal at the receiver by extracting relevant data from a signal that has noise and interference. For example, detecting a signal might involve recognizing a specific synchronization pattern or frequency that indicates the start of a data packet. In ‘detecting’, the input is a stream of I/Q samples and the output is a stream of bits. Detection may be performed before decoding.

A ‘Viterbi detector’ is a detector that uses a Viterbi detuning algorithm to detect bits, maintaining a history of all possible past bit sequences and finds a most likely sequence of bits. It may be susceptible to carrier frequency errors.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Aspects of the present disclosure are described, by way of example only, with reference to the following drawings, in which:

FIG. 1 shows an apparatus in accordance with the present disclosure;

FIG. 2 shows a Viterbi detuning algorithm used in an apparatus in accordance with the present disclosure;

FIG. 3 shows a Viterbi detuning algorithm that can be used in an apparatus in accordance with the present disclosure;

FIG. 4 shows application of a Viterbi detuning algorithm in an apparatus in accordance with the present disclosure;

FIG. 5 shows a Viterbi detuning algorithm that can be used in an apparatus in accordance with the present disclosure;

FIG. 6 illustrates the performance of applying a tuning parameter in accordance with the present disclosure;

FIG. 7 represents example method steps according to an aspect of the present disclosure;

FIG. 8 shows an apparatus in accordance with the present disclosure;

FIG. 9 illustrates the performance of applying a tuning parameter in accordance with the present disclosure; and

FIG. 10 represents example method steps according to an aspect of the present disclosure.

### DETAILED DESCRIPTION

Some signal detection techniques at the receiver side of the wireless communications system may be particularly susceptible to carrier frequency errors and their performance may be degraded if carrier frequency errors are not reduced adequately.

Therefore, it may be desirable to provide an improved solution for reducing carrier frequency errors in wireless communications system.

Simple techniques for reducing the effect of carrier frequency offset errors have been proposed. However, these methods often have the disadvantage of resulting in degraded performance if carrier frequency errors are not reduced adequately.

As described above, it is desirable to provide an improved solution for reducing the effect of carrier frequency offset errors at a receiver of a wireless communications system.

The present inventors have recognised that a way in which to reduce the effect of carrier frequency offset errors on a receiver of a wireless communications system that includes a Viterbi detector is to improve the effectiveness of the Viterbi detector. This is done by introducing a tuning parameter to the Viterbi detuning algorithm. Essentially, they have come up with a scheme to automatically detune the Viterbi detector to deal dynamically with the instantaneously carrier frequency offset error. The Viterbi detector is particularly sensitive to carrier frequency offset errors and has to be detuned based on the level of carrier frequency offset present in the transmitted bit stream. The larger the carrier frequency offset error, the more the Viterbi should be detuned. A conventional approach may be to detune the Viterbi for a worse case carrier frequency offset error, resulting in the largest trade off in Viterbi performance. In the approach of the present disclosure, the Viterbi detector may be dynamically detuned based on a live estimate of the carrier frequency offset error, hence maximizing the Viterbi detector's performance for the current level of carrier frequency offset error. Further, the present inventors have recognised that an automatic frequency control block may be used to provide real-time detection of carrier frequency offset errors and then an automatic frequency control residual block may be used to apply the tuning parameter to the Viterbi detuning algorithm, the tuning parameter being a function of the carrier frequency offset error such that no detuning is applied when the error is negligible and increasing as the error increases, thus providing the optimal level of immunity for a given carrier frequency offset error at any one time.

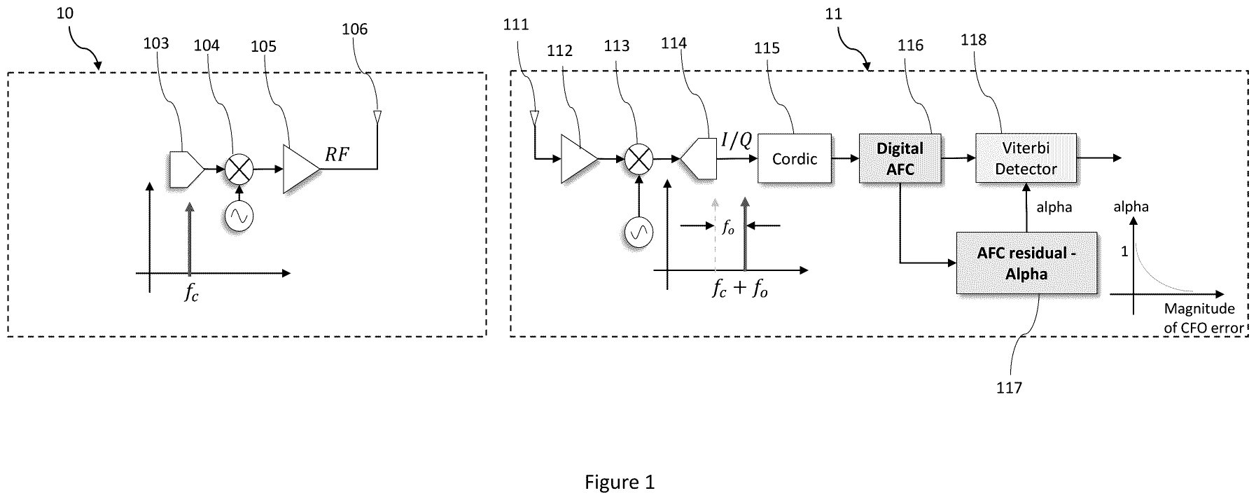

FIG. 1 shows an apparatus for tuning a Viterbi detector at a receiver of a wireless communications system in accordance with the present disclosure.

At the transmitter 10 side, the signal is converted from digital-to-analog domain by a DAC 103, a mixer 104 applies a carrier frequency to the signal, the signal is amplified by an amplifier 105 and then transmitted via a transmit antenna 106.

The apparatus, at the receiver 11 side, comprises a receive antenna 111 for receiving the transmitted bit stream, an amplifier 112 for receiving the signal, a mixer 113 to bring the signal back to baseband, an analog-to-digital converter, ADC, 114 and the symbols are converted back into phase trajectory by the CORDIC 115. The amplifier 112 may be a low noise amplifier. The Viterbi detector converts the phase trajectory back into a bit sequence. The Viterbi detector 118 is sensitive to carrier frequency offset errors but tuning the Viterbi detector can mitigate this effect. An automatic frequency control (AFC) block 116 is configured to detect a frequency mismatch between a carrier frequency and a local oscillator frequency at the receiver to derive a carrier frequency offset error. An automatic frequency control (AFC) residual block 117 is configured to determine a tuning parameter based on a carrier frequency offset error, the tuning parameter being a value between 1 and 0. The Viterbi detector 118 is configured to apply the tuning parameter to a Viterbi detuning algorithm in order to reduce the carrier frequency offset error.

If the automatic frequency control block 116 determines there is no or negligible carrier frequency offset error, for example, at or below a lower threshold of carrier frequency offset error, then the automatic frequency control residual block 117 may determine the tuning parameter to be 1, thus resulting in a best performance of the Viterbi detector. However, if the automatic frequency control block 116 determines there is finite carrier frequency offset error, and if the tuning parameter is left as 1, then the performance of the Viterbi detector starts to deteriorate. Thus, according to the present disclosure, if the automatic frequency control block 116 determines there is finite carrier frequency offset error, then the automatic frequency control residual block 117 may determine a tuning parameter that increases from 1 and tend towards 0, trading off performance of the Viterbi detector for robustness of the apparatus. Thus, by making the tuning parameter a function of the carrier frequency offset error, for example, proportional to the carrier frequency error, the benefit of using the Viterbi detector is weighed up against tolerance to carrier frequency offset error. In this case, when the tuning parameter is 0, an output of the Viterbi detuning algorithm may be an output of a low pass filter of the Viterbi detector 118.

At or above an upper threshold carrier frequency offset error, the tuning parameter applied to the Viterbi detuning algorithm, as determined by the automatic frequency control residual block 117, may be 1. In this case, the Viterbi detuning algorithm is bypassed.

The automatic frequency control residual block 117 may apply the tuning as a function of the instantaneous offset. In other words, it dynamically or automatically (preferably, in a feedforward manner) adjusts the tuning parameter based on the carrier frequency offset error. Advantageously, this optimizes the performance of the apparatus in order to obtain the best trade off in performance vs robustness.

The value of the tuning parameter may be linearly or non-linearly proportional to the carrier frequency error. Although in FIG. 1 it is shown that the relationship is non-linear, in other examples of the present disclosure, the relationship may be linear.

A look up table may be used to find the value of the tuning parameter for a given magnitude of the carrier frequency offset error. For example, if the carrier frequency offset error is 0, then the tuning parameter may be 1; if the carrier frequency offset error is +/−5 kHz, then the tuning parameter may be 0.6; if the If carrier frequency offset error is +/−20 kHz, then the tuning parameter may be 0.06.

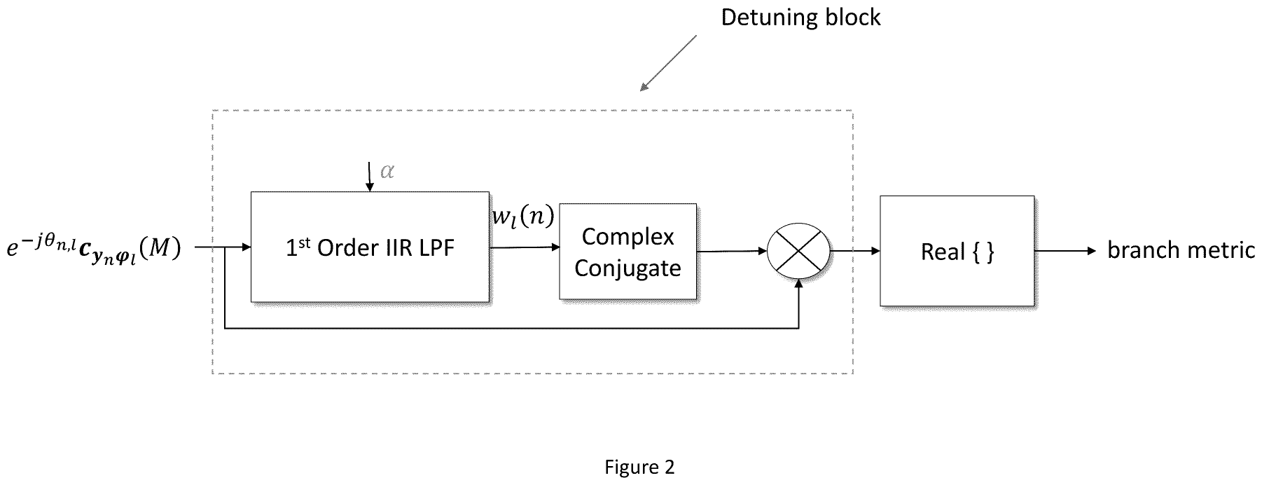

FIG. 2 shows how a Viterbi detuning algorithm is used in an apparatus in accordance with the present disclosure.

The Viterbi detuning algorithm comprises low pass filtering of a cross correlation of the receiver input with candidate transient waveforms multiplied by the historic phase waveform. The pole frequency of low pass filter is controlled by the tuning parameter, α. The low pass filter may be a first order infinite impulse response low pass filter. A complex conjugate output of the low pass filter may be multiplied with the input. A Real value of the output may be taken as a branch metric to be used in a reminder of the Viterbi detection process.

The output of the low pass filter may be described as a times the previous output plus one minus a times the input. The a term may be a number from 0 to 1.

An output to the cross correlation part of the Viterbi detuning algorithm may comprises:

$${w}_{l} ( n ) = α {w}_{l} ( n - 1 ) + ( 1 - α ) {e}^{- j {θ}_{n , l}} {c}_{{y}_{n} {φ}_{l}} ( M )$$

wherein wₗ (n) is the output to the low pass filter,
wherein α is the tuning parameter,
wherein wₗ (n−1) is a previous output of the low pass filter,
wherein e^{-jθ(n,l)} is a historic phase waveform,
and wherein c_{yn φl} (M) is a cross correlation of the receiver input with candidate transient waveforms.

The historic phase waveform may be a complex number, comprising a real term and an imaginary term.

At time 0, an initial value of wₗ (−1)=1, i.e. the initial value of the output of the low pass filter.

If the automatic frequency control block determines there is no or negligible carrier frequency offset error, for example, at or below a lower threshold of carrier frequency offset error, then the automatic frequency control residual block may determine the tuning parameter to be 1. When the tuning parameter is 1, the output to the cross correlation part of the Viterbi detuning algorithm is e^{-jθ(n,l)} multiplied by c_{yn φl} (M), i.e. the historic phase waveform multiplied by the cross correlation of the receiver input with a candidate transient waveform . . . wₗ (0)=wₗ (−1)=1. wₗ (1)=wₗ (0)=1. In other words, when the tuning parameter is 1, the detuning block does nothing and the Viterbi detuning algorithm is bypassed; when the detuning parameter is 1, the output of the low pass filter becomes a constant.

If the automatic frequency control block determines there is finite or substantial carrier frequency offset error, for example at or above an upper lower threshold of carrier frequency offset error, the tuning parameter applied to the Viterbi detuning algorithm, as determined by the automatic frequency control residual block, may be 0<α<1, and the detuning block is active. When the tuning parameter is α<1, the output to the cross correlation part of the Viterbi detuning algorithm is wₗ (n−1)≠1, but is a low pass filtered version of the input, where the pole frequency of the filter is determined by the tuning parameter. Then by forming the product of the filter input with the complex conjugate of the low pass filter output, the deleterious effect of the frequency offset error on the branch metric and hence the Viterbi performance is mitigated.

In past systems, the tuning parameter is fixed, often taking a worst case carrier frequency offset error in order to set its value. In contract, in the present disclosure, the tuning parameter is dynamically and/or automatically set so as to achieve optimal performance from the detuning block at any one time.

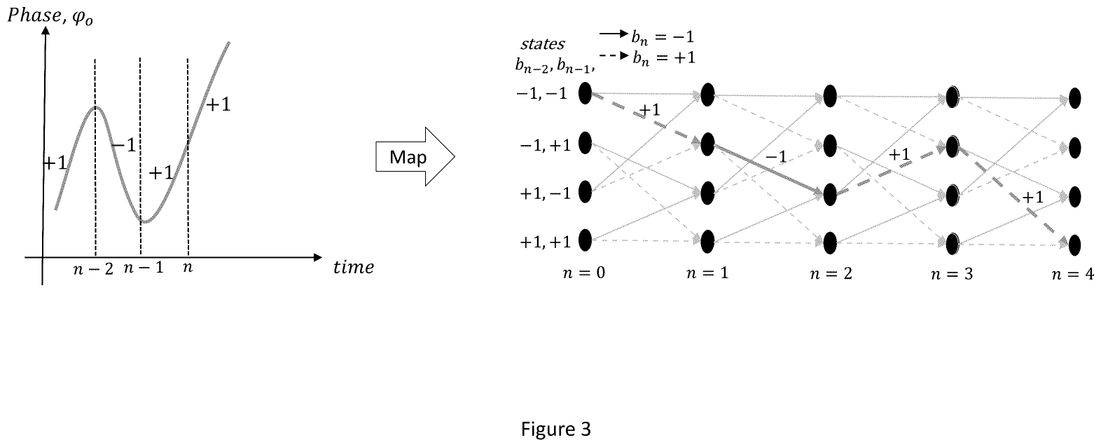

FIG. 3 shows a Viterbi detuning algorithm, which is the algorithm used to detect bits, maintaining a history of all possible bit sequences and finds a most likely sequence of bits. It receives a signal and calculates branch metrics by comparing each of the possible transmitted symbols, the branch metrics representing a likelihood of each possible transmitted symbol being the correct one. Then, the algorithm computes path metrics, i.e., cumulative likelihoods, by summing the branch metrics along potential paths through a trellis diagram, each path representing a possible sequence of transmitted bits. At each step, the algorithm may perform an add-compare-select operation to choose the most likely path (and pruning the paths having lower likelihood), adding the branch metrics to the path metrics, comparing the results, and selecting the path with the highest likelihood. When the entire sequence is processed, the algorithm traces back through the trellis to determine the most likely sequence of transmitted bits. The most probably sequence of bits is then output by the Viterbi detuning algorithm.

FIG. 3 shows the process of mapping phase trajectories to a Phase Trellis and using the Viterbi detuning algorithm for phase detection, used in examples of the present disclosure.

On the left side FIG. 3, there is a graph depicting the evolution of a GFSK phase trajectory representing phase states corresponding to the transmitted bits labeled “+1” and “−1.” The horizontal axis represents time, while the vertical axis represents phase (φ₀). Dashed vertical lines indicate specific points in time (n−2, n−1, and n), marking critical moments in the phase transitions.

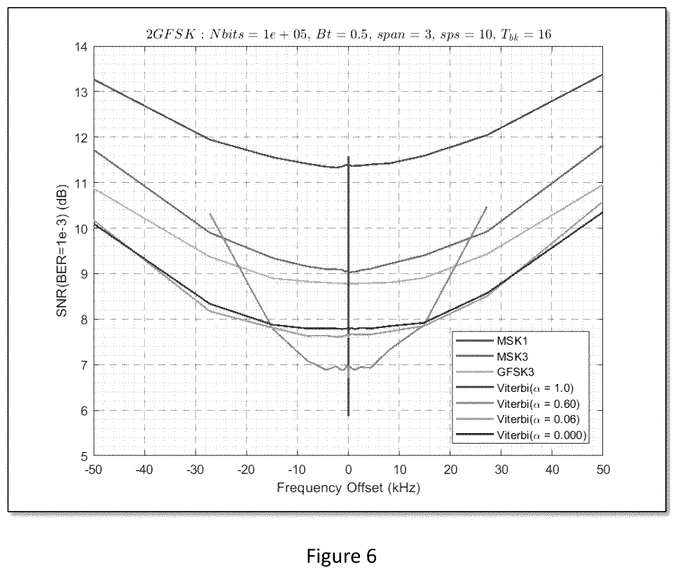

An arrow labeled “Map” points towards the right side of FIG. 6, indicating the transition from the phase trajectories to the Phase Trellis. This mapping process involves plotting the actual phase trajectory of the signal onto the trellis, considering both Transient (current) and Cumulative (past) phase information. This ensures that the history of the signal is taken into account during the detection process.

On the right side of FIG. 3, the Phase Trellis is illustrated. This diagram shows state transitions over discrete time intervals (n=0 to n=4), with each state labeled “+1” or “−1.” The arrows indicate possible paths between states, corresponding to changes in phase. The label “Gaussian filter of span=3 bits” suggests that the signal has been filtered to smooth out the transitions.

The Viterbi algorithm is then used to efficiently search the trellis for the best match to the observed phase trajectory. By finding the most likely sequence of states, the algorithm minimizes the error between the observed and possible trajectories. This combination of the Phase Trellis and the Viterbi algorithm results in a maximum likelihood sequence detector, which identifies the most probable sequence of transmitted phases. This process enhances the accuracy of phase detection compared with a simpler detector.

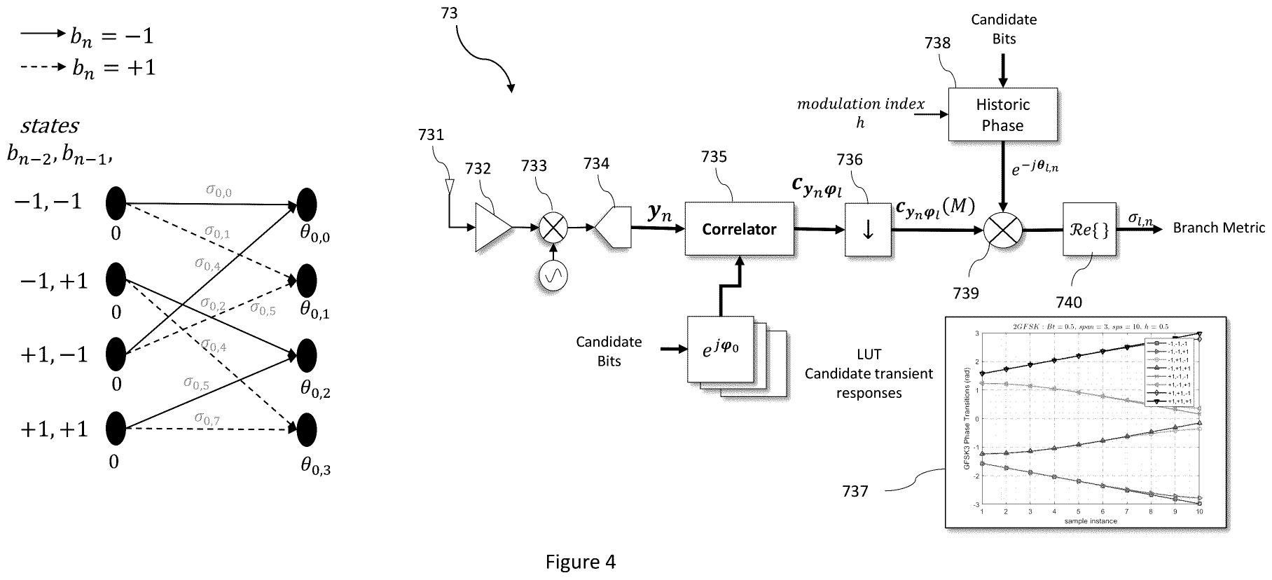

FIG. 4 shows the forward path of a Viterbi detector used in the examples of the present disclosure. It shows branch metric computations, which measure the likelihood that a received signal waveform matches a candidate waveform. On the left side of FIG. 4, a current incoming bit and two previous bits are considered together. If the current incoming bit is −1, this is represented by a continuous arrow and if the current incoming bit is +1, this is represented by a dashed arrow. The possible states for the two previous bits are shown as (−1, −1), (−1, +1), (+1, −1), and (+1, +1). The branch metric for each state is represented by a Greek letter symbol (α), indicating a likelihood of the previous sequence of bits. The likelihoods are then pruned (discarded) and a historic or cumulative phase is calculated.

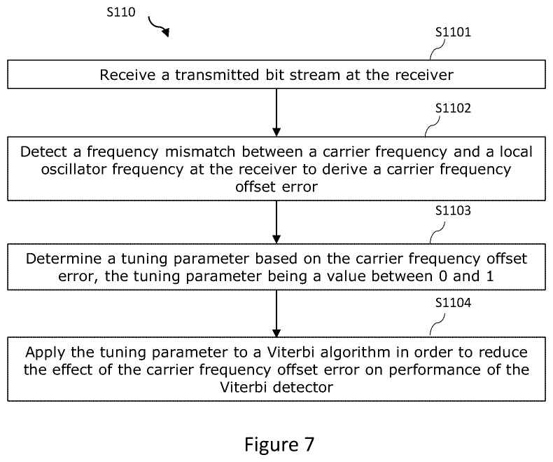

A transmitted signal is received at the receive antenna 731 of the receiver 73. The transmitted signal is amplified by amplifier 732, its frequency is translated back down to DC by a mixer 733 and then converted from analog-to-digital domain by an ADC 734. The amplifier 732 may be a low noise amplifier. For detection, a correlator 735 compares two inputs, a measure phase from an IQ signal and a table of possible phase trajectories, i.e. a lookup table (LUT) 737 shows the possible candidate transient responses, depicted as a graph in FIG. 7, indicating how well each phase matched each of the 8 possible phases. An output of the correlator is downsampled by a downsampler 736 (which samples the correlation (vector) result in the middle of the symbol to extract the maximum correlation value over that time. Alternatively to using a downsampler, a decimator may be used, which may have an anti-aliasing filter followed by a downsampler) and then it is added to a historic or cumulative phase 738 by a multiplier 739 and the real part of a complex number 740 of the output of the addition is the branch metric. The multiplier 739 as shown in FIG. 4 is an example of an adder that may also be used as described in other examples of the present disclosure.

In the Viterbi detector of FIG. 4, the rate of operation in the digital domain is at an oversampled rate i.e. at an Over Sampling Ratio (OSR) relative to the symbol rate, for example, OSR=10.

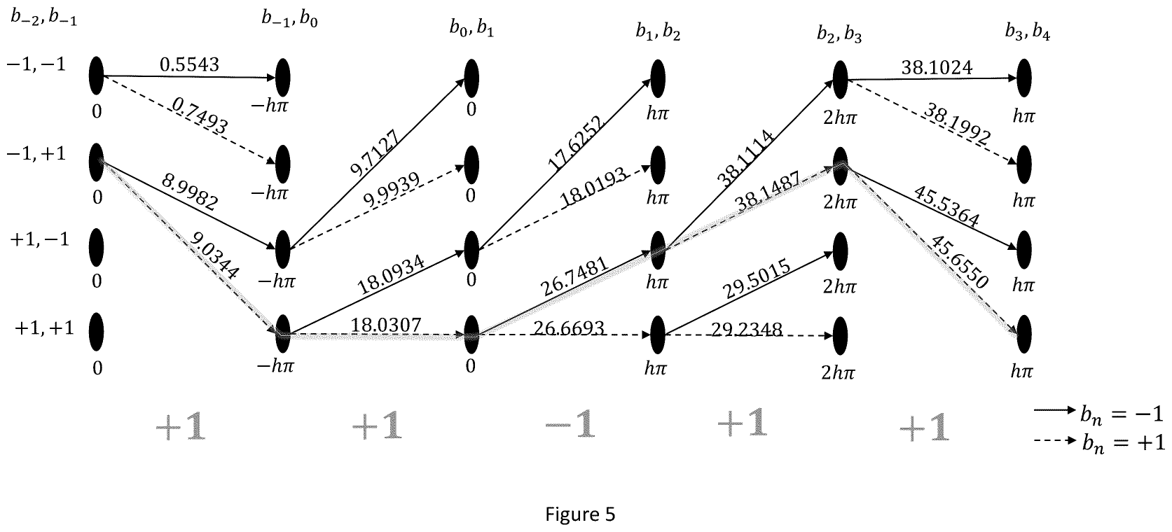

FIG. 5 shows Viterbi traceback used in the examples of the present disclosure. A trellis diagram shows each of the possible paths and path metrics for different states at each time, or bit span. The numbers along each path represent accumulated metrics used to determine which path is most likely correct. The numbers shown in FIG. 5 are examples of path metric calculations only.

Using a Transmit Pulse shaping filter with an impulse response that spans 3-bits, there are initially 8 candidate transmitted waveforms at each step. However, these candidates can be pruned back to a 4-state Trellis with paths with higher branch metrics, while the others are eliminated, using a Viterbi detuning algorithm. The pruning process significantly helps in reducing the computational complexity and focusing on the most likely paths. The path that is highlighted is the most likely sequences of states, labelled as the “winner” paths.

FIG. 6 illustrates the performance of applying a tuning parameter a in accordance with the present disclosure.

In FIG. 6, a plot of Viterbi detector performance (as well as simple threshold detector performance) versus various tuning parameters in terms of carrier frequency offset error is shown. The x-axis of FIG. 6 shows frequency offset in Hz, ranging from −50 to 50 kHz, and the y-axis of FIG. 6 shows the Signal-to-Noise Ratio in dB, to achieve a Bit Error Rate of 1e⁻³, ranging from approximately 5 to 14 dB. The lower the required SNR, the better the system is able to tolerate more noise. The plot may be used to look at the carrier frequency offset error and automatically find the optimal tuning parameter to be used in the Viterbi detuning algorithm.

The lines representing the MSK1, MSK3, GFSK3 simple threshold detectors show relatively stable performance across the entire frequency offset range, indicating that these schemes are less sensitive to frequency offset errors. However, whilst the simple detectors are insensitive to frequency offset error, they require high SNR to achieve a BER of 1e⁻³.

The Viterbi detectors achieve better performance and require lower SNR to achieve a BER of 1e⁻³. If there is no carrier frequency offset error, then the Viterbi detector with a tuning parameter α=1 can achieve up to 6 dB for a Bit Error Rate of 1e⁻³. However, if there is a small frequency offset error, the Viterbi detector with a tuning parameter α=1 would fail.

The SNR that is required increases as the tuning parameter reduces from α=1. When the tuning parameter α=0.6, this gives the best performance between −7 and 7 kHz at 7 dB, and there is a trade off between tolerance vs performance. As the detector is detuned as the tuning parameter α is reduced, the performance is traded off for robustness to frequency offset errors. Thus, for the particular conditions shown in FIG. 6, it can be seen that when the value of the tuning parameter is less than or equal to 0.06, a large frequency offset error of +/−40 kHz can be tolerated with a required SNR range of 7.75 to 10 dB, outperforming the simpler threshold detectors MSK1, MSK33, and GFSK3.

FIG. 7 represents example method steps S110 according to an aspect of the present disclosure. In general, at step S1101, a transmitted bit stream is received at the receiver. At step S1102, a frequency mismatch is detected between a carrier frequency and a local oscillator frequency at the receiver to derive a carrier frequency offset error. At step S1103, a tuning parameter is determined based on the carrier frequency offset error, the tuning parameter being a value between 0 and 1. Finally, at step S1104, the tuning parameter is applied to a Viterbi detuning algorithm in order to reduce the carrier frequency offset error.

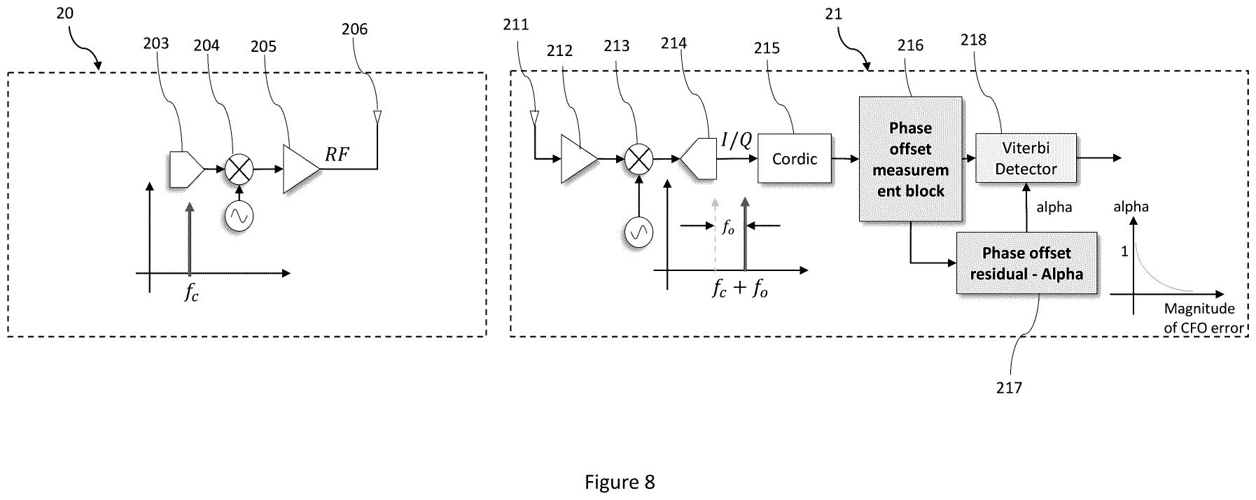

FIG. 8 shows an apparatus for tuning a Viterbi detector at a receiver of a wireless communications system in accordance with the present disclosure.

Relative to FIG. 1, instead of a digital AFC 116, a phase offset measurement block 216 is shown. Relative to FIG. 1, instead of an AFC residual block 117, a phase offset residual block 217 is shown. Otherwise, each of the other features are labelled and behave correspondingly.

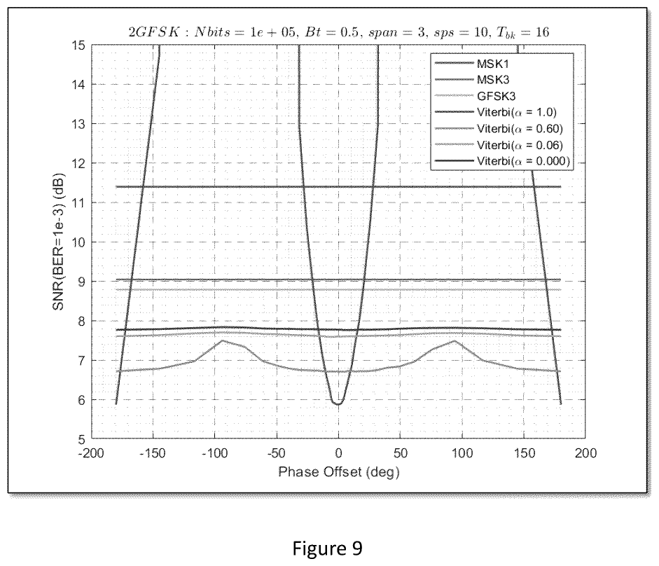

FIG. 9 illustrates the performance of applying a tuning parameter a in accordance with the present disclosure.

In FIG. 9, a plot of Viterbi detector performance (as well as simple threshold detector performance) versus various tuning parameters in terms of carrier phase offset error is shown. The x-axis of FIG. 9 shows phase offset between TX and RX local oscillators in degrees, ranging from −200 to 200 degrees, and the y-axis of FIG. 6 shows the Signal-to-Noise Ratio in dB, to achieve a Bit Error Rate of 1e⁻³, ranging from approximately −2 to 16 dB. The lower the required SNR, the better the system is able to tolerate more noise. The plot may be used to look at the carrier phase offset error and automatically find the optimal tuning parameter to be used in the Viterbi detuning algorithm.

The lines representing the MSK1, MSK3, GFSK3 simple threshold detectors show relatively stable performance across the entire phase offset range, indicating that these schemes are less sensitive to phase offset errors. However, whilst the simple detectors are completely insensitive to phase offset error, they require high SNR to achieve a BER of 1e⁻³.

The Viterbi detectors achieve better performance and require lower SNR to achieve a BER of 1e⁻³.

The line representing Viterbi detecting with α=0.006 and the line representing Viterbi detecting with α=0.000 show high tolerance to carrier phase offset error, while maintaining good BER performance relative to the simple detectors. In the case of Viterbi detecting with α=0.000, this affords the maximum detuning but there is a trade off in processing gain for most robustness to offset errors.

The line representing the Viterbi detector with a tuning parameter α=1.0 shows more variation over the range of phase offsets (between +/−180 degrees), indicating a higher sensitivity to phase errors between +/−5 degrees and +/−180 degrees. For a tuning parameter α=1.0, the best performance can be achieved (SNR<6 dB) over a phase range +/−5 degrees. However, this is only practicable for a narrow phase offset range.

The line representing the Viterbi detector with a tuning parameter α=0.6 has the best performance of 7 dB for BER=1e⁻³ from +/−5 degrees to +/−180 degrees.

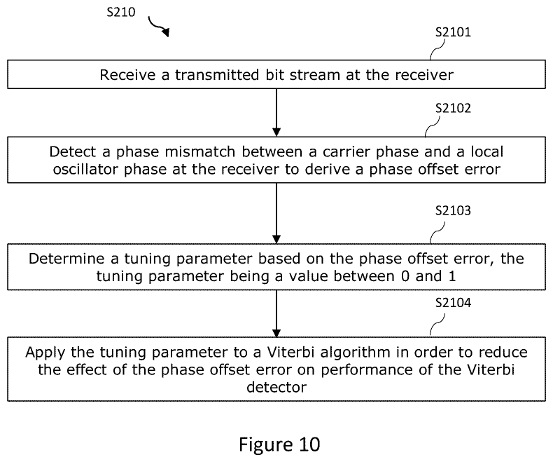

FIG. 10 represents example method steps S210 according to an aspect of the present disclosure. In general, at step S2101, a transmitted bit stream is received at the receiver. At step S2102, a phase mismatch is detected between a carrier phase and a local oscillator phase at the receiver to derive a carrier phase offset error. At step S2103, a tuning parameter is determined based on the carrier phase offset error, the tuning parameter being a value between 0 and 1. Finally, at step S2104, the tuning parameter is applied to a Viterbi detuning algorithm in order to reduce the effect of the phase offset error on performance of the Viterbi detector.

| | |
|---|---|
| Transmitter | 10, 20 |
| DAC | 103, 203 |
| Mixer | 104, 204 |
| Amplifier | 105, 205 |
| Transmit antenna | 106, 206 |
| Receiver | 11, 21 |
| Receive antenna | 111, 211, 731 |
| Amplifier | 112, 212, 732 |
| Mixer | 113, 213, 733 |
| ADC | 114, 115, 734 |
| CORDIC | 115, 215 |
| Digital AFC | 116 |
| Phase offset measurement block | 216 |
| AFC residual block | 117 |
| Phase error residual block | 217 |
| Viterbi detector | 118, 218, 1017 |
| Correlator | 735 |
| Downsampler | 736 |
| LUT | 737 |
| Historic phase | 738 |
| Multiplier | 739 |
| Real part | 740 |

The skilled person will readily appreciate that various alterations or modifications may be made to the above-described aspects of the disclosure without departing from the scope of the disclosure. For example, features of two or more of the above examples may be combined and still fall within the scope of the present disclosure.

### Numbered Aspects

By way of non-limiting example, some aspects of the disclosure are set out in the following numbered clauses.

Numbered Clause 1. A method of tuning a Viterbi detector at a receiver of a wireless communications system, the method comprising:
receiving a transmitted bit stream at the receiver;
detecting a frequency mismatch between a carrier frequency and a local oscillator frequency at the receiver to derive a carrier frequency offset error;
determining a tuning parameter based on the carrier frequency offset error, the tuning parameter being a value between 0 and 1; and
applying the tuning parameter to a Viterbi detuning algorithm in order to reduce the effect of the carrier frequency offset error on performance of the Viterbi detector.
   Numbered Clause 2. The method according to Numbered Clause 1, wherein both the carrier frequency and the local oscillator frequency at the receiver comprise errors.
   Numbered Clause 3. The method according to Numbered Clause 1 or 2, wherein the carrier frequency is a center frequency of a transmitted carrier signal and the local oscillator frequency is a center frequency of the local oscillator.
   Numbered Clause 4. The method according to any preceding Numbered Clause, wherein an input and an output to the Viterbi detuning algorithm is a complex number.
   Numbered Clause 5. The method according to any preceding Numbered Clause, wherein applying the tuning parameter to the Viterbi detuning algorithm comprises low pass filtering.
   Numbered Clause 6. The method according to Numbered Clause 5, wherein low pass filtering comprises low pass filtering of a cross correlation of the receiver input with candidate transient waveforms multiplied by the historic phase waveform.
   Numbered Clause 7. The method according to Numbered Clause 6, further comprising multiplying a complex conjugate output of the low pass filtering with the input to the low pass filter.
   Numbered Clause 8. The method according to Numbered Clause 7, further comprising taking a Real value of the output of the low pass filtering as a branch metric to be used in a reminder of the Viterbi detection process.
   Numbered Clause 9. The method according to any preceding Numbered Clause, wherein the method further comprises:
determining a tuning parameter of 1 when a carrier frequency offset error below a lower threshold is detected.
   Numbered Clause 10. The method according to Numbered Clause 9, wherein determining the tuning parameter of 1 when no carrier frequency offset error is detected.
   Numbered Clause 11. The method according to Numbered Clause 9 or 10, further comprising bypassing the Viterbi detuning algorithm.
   Numbered Clause 12. The method according to any preceding Numbered Clause, wherein the method further comprises:
determining the tuning parameter of 0 when a carrier frequency offset error above an upper threshold is detected.
   Numbered Clause 13. The method according to any preceding Numbered Clause, wherein the tuning parameter is a function of the magnitude of the carrier frequency offset error and ranges between 0 and 1, the tuning parameter being 1 when the carrier frequency offset error is zero, and tending towards 0 as the carrier frequency offset error increases.
   Numbered Clause 14. The method according to any preceding Numbered Clause, wherein the method further comprises:
dynamically adjusting the tuning parameter based on the carrier frequency offset error.
   Numbered Clause 15. The method according to any preceding Numbered Clause, wherein the method further comprises:
automatically adjusting the tuning parameter based on the carrier frequency offset error.
   Numbered Clause 16. The method according to any preceding Numbered Clause, wherein detecting a frequency mismatch comprises performing a Fast Fourier Transform on the transmitted bit stream at the receiver or measuring a frequency error using a feedforward or feedback automatic frequency control loop.
   Numbered Clause 17. The method according to any preceding Numbered Clause, wherein the transmitted bit stream is encoded and/or modulated, and the method further comprises decoding and/or demodulating the transmitted bit stream.
   Numbered Clause 18. The method according to any preceding Numbered Clause, further comprising:
outputting a detected bit stream from the receiver.
   Numbered Clause 19. An apparatus for tuning a Viterbi detector at a receiver of a wireless communications system, the apparatus comprising:
an automatic frequency control block, configured to detect a frequency mismatch between a carrier frequency and a local oscillator frequency at the receiver to derive a carrier frequency offset error;
an automatic frequency control residual block, configured to determine a tuning parameter based on a carrier frequency offset error, the tuning parameter being a value between 0 and 1; and
   a Viterbi detector, configured to apply the tuning parameter to a Viterbi detuning algorithm in order to reduce the effect of the carrier frequency offset error on performance of the Viterbi detector.
      Numbered Clause 20. The apparatus of Numbered Clause 19, wherein the Viterbi detector comprises a low pass filter, preferably a first order low pass filter.
      Numbered Clause 21. The apparatus of Numbered Clause 19 or 20, wherein the Viterbi detector is configured to dynamically adjust the tuning parameter based on the carrier frequency offset error.
      Numbered Clause 22. The apparatus of any of Numbered Clauses 19 to 21, wherein the Viterbi detector is configured to automatically adjust the tuning parameter based on the carrier frequency offset error
      Numbered Clause 23. The apparatus of any of Numbered Clauses 19 to 22, further comprising an encoder and decoder and/or a modulator and a demodulator.
      Numbered Clause 24. A method of tuning a Viterbi detector at a receiver of a wireless communications system, the method comprising:
receiving a transmitted bit stream at the receiver;
detecting a phase mismatch between a carrier phase and a local oscillator phase at the receiver to derive a carrier phase offset error;
determining a tuning parameter based on the carrier phase offset error, the tuning parameter being a value between 0 and 1; and
   applying the tuning parameter to a Viterbi detuning algorithm in order to reduce the effect of the carrier phase offset error on performance of the Viterbi detector.
      Numbered Clause 25. An apparatus for tuning a Viterbi detector at a receiver of a wireless communications system, the apparatus comprising:
an automatic phase control block, configured to detect a phase mismatch between a carrier phase and a local oscillator phase at the receiver to derive a carrier phase offset error;
an automatic phase control residual block, configured to determine a tuning parameter based on a carrier phase offset error, the tuning parameter being a value between 0 and 1; and
   a Viterbi detector, configured to apply the tuning parameter to a Viterbi detuning algorithm in order to reduce the effect of the carrier phase offset error on performance of the Viterbi detector.

1. A method of tuning a Viterbi detector at a receiver of a wireless communications system, the method comprising:
receiving a transmitted bit stream at the receiver;
detecting a frequency mismatch between a carrier frequency and a local oscillator frequency at the receiver to derive a carrier frequency offset error;
determining a tuning parameter based on the carrier frequency offset error, the tuning parameter being a value between 0 and 1; and
applying the tuning parameter to a Viterbi detuning algorithm in order to reduce an effect of the carrier frequency offset error on performance of the Viterbi detector.

2. The method according to claim 1, wherein both the carrier frequency and the local oscillator frequency at the receiver comprise errors.

3. The method according to claim 1, wherein the carrier frequency is a center frequency of a transmitted carrier signal and the local oscillator frequency is a center frequency of the local oscillator.

4. The method according to claim 1, wherein an input and an output to the Viterbi detuning algorithm is a complex number.

5. The method according to claim 1, wherein applying the tuning parameter to the Viterbi detuning algorithm comprises low pass filtering.

6. The method according to claim 5, wherein low pass filtering comprises low pass filtering of a cross correlation of a receiver input with candidate transient waveforms multiplied by a historic phase waveform.

7. The method according to claim 6, further comprising multiplying a complex conjugate output of the low pass filtering with the input to the low pass filter, preferably further comprising taking a Real value of the output of the low pass filtering as a branch metric to be used in a reminder of the Viterbi detection process.

8. The method according to claim 1, wherein the method further comprises:
determining a tuning parameter of 1 when a carrier frequency offset error below a lower threshold is detected or when no carrier frequency offset is detected.

9. The method according to claim 8, wherein determining the tuning parameter of 1 when no carrier frequency offset error is detected.

10. The method according to claim 9, further comprising bypassing the Viterbi detuning algorithm.

11. The method according to claim 8, further comprising bypassing the Viterbi detuning algorithm.

12. The method according to claim 1, wherein the method further comprises:
determining the tuning parameter of 0 when a carrier frequency offset error above an upper threshold is detected.

13. The method according to claim 1, wherein the tuning parameter is a function of a magnitude of the carrier frequency offset error and ranges between 0 and 1, the tuning parameter being 1 when the carrier frequency offset error is zero, and tending towards 0 as the carrier frequency offset error increases.

14. The method according to claim 1, wherein the method further comprises:
automatically adjusting the tuning parameter based on the carrier frequency offset error.

15. The method according to claim 1, wherein detecting a frequency mismatch comprises performing a Fast Fourier Transform on the transmitted bit stream at the receiver or measuring a frequency error using a feedforward or feedback automatic frequency control loop.

16. The method according to claim 1, further comprising:
outputting a detected bit stream from the receiver.

17. An apparatus for tuning a Viterbi detector at a receiver of a wireless communications system, the apparatus comprising:
an automatic frequency control block, configured to detect a frequency mismatch between a carrier frequency and a local oscillator frequency at the receiver to derive a carrier frequency offset error;
an automatic frequency control residual block, configured to determine a tuning parameter based on a carrier frequency offset error, the tuning parameter being a value between 0 and 1; and
a Viterbi detector, configured to apply the tuning parameter to a Viterbi detuning algorithm in order to reduce an effect of the carrier frequency offset error on performance of the Viterbi detector.

18. The apparatus of claim 17, wherein the Viterbi detector comprises a low pass filter, preferably a first order low pass filter.

19. The apparatus of claim 17, wherein the Viterbi detector is configured to automatically adjust the tuning parameter based on the carrier frequency offset error.

20. An apparatus for tuning a Viterbi detector at a receiver of a wireless communications system, the apparatus comprising:
an automatic phase control block, configured to detect a phase mismatch between a carrier phase and a local oscillator phase at the receiver to derive a carrier phase offset error;
an automatic phase control residual block, configured to determine a tuning parameter based on a carrier phase offset error, the tuning parameter being a value between 0 and 1; and
a Viterbi detector, configured to apply the tuning parameter to a Viterbi detuning algorithm in order to reduce an effect of the carrier phase offset error on performance of the Viterbi detector.
